(19) United States
(12) Patent Application Publication
(10) Pub. No.: US 2015/0367593 A1
(43) Pub. Date: Dec. 24, 2015

(54) ROLL OF NON-UNIFORM THICKNESS TAPE AND METHOD FOR MAKING SAME

(71) Applicant: Gary D. LANGEMAN, Lemington (CA)

(72) Inventor: Gary D. LANGEMAN, Lemington (CA)

(73) Assignee: LANGEMAN MANUFACTURING LIMITED, Leamington, ON (CA)

(21) Appl. No.: 14/420,579

(22) PCT Filed: Jul. 25, 2012
(86) PCT No.: PCT/CA2012/000702

§ 371 Date: Sep. 3, 2015

(51) Int. Cl. B32B 3/04; C09J 7/02; B32B 37/14; B32B 3/08; B32B 37/20

(52) U.S. Cl. CPC B32B 3/04; B32B 3/08; B32B 37/20; B32B 37/142; C09J 7/026; B32B 2255/12; B32B 2255/10; B32B 2307/5825; B32B 2405/00; C09J 2205/10

(57) ABSTRACT

The present invention provides a method for folding a non-uniform tape where the tape near a first longitudinal edge is thicker than the rest of the tape because of reinforcement of that first edge. In preferred embodiments, the non-uniform strip has a longitudinal strip along the top of the tape near the first edge causing its thickness to be about double that of the rest of the tape, the tape having an adhesive layer on the bottom. The method involves folding the tape along a fold line near the second longitudinal edge so that the bottom of the folded portion is adjacent and adhered to the bottom of the neighbouring portion of the tape, and the tape is then rewound into a roll.

### FIELD OF THE INVENTION

The present invention relates generally to methods of rewinding tape to form a roll, and to rolls of tape formed by such methods, and more particularly to methods of folding non-uniform tape to facilitate winding the tape into a roll, and to rolls of folded tape formed by such methods.

### BACKGROUND OF THE INVENTION

Tape is used for many purposes. Tape is generally formed from a longitudinal strip of an elongated substrate material, such as paper or a plastic, with a pressure-sensitive adhesive layer formed on one side of the substrate, which side we refer to herein as the bottom side. The strip of substrate has two longitudinal edges that are generally parallel to each other so that the tape has a uniform width over its entire length. Such tape is typically rewound onto a core to form a roll of tape for use by users, who remove portions of the tape from the roll by pulling a length of tape from the roll and then tearing or cutting the tape in the transverse direction. A release coating may also be applied to the top side of the substrate to facilitate removing tape from a roll.

One example of a type of tape is masking tape, which is widely used by painters and others applying a coating (such as paint or lacquer) to a surface in order to define a sharp edge on the portion of the surface being coated. The masking tape protects a portion of the surface that is not to be coated. The adhesive layer permits the masking tape to be removably attached to the surface. The coating may then be applied to the surface so that the first longitudinal edge of the masking tape is also covered by the coating. The tape can then be removed, leaving a straight and well defined edge of the portion of the surface that is coated, corresponding to the position of the first longitudinal edge of the tape.

### SUMMARY OF THE INVENTION

The following presents a simplified summary of the disclosure in order to provide a basic understanding to the reader. This summary is not an extensive overview of the disclosure and it does not necessarily identify key/critical elements of the invention or delineate the scope of the invention. Its sole purpose is to present some concepts disclosed herein in a simplified form as a prelude to the more detailed description that is presented later.

The present invention provides a method for forming tape having non-uniform thickness into a roll, the non-uniform tape comprising a longitudinally elongated substrate having top and bottom sides, first and second longitudinal edges and a width (Wt), the non-uniform tape further comprising an adhesive layer formed on the bottom side of the substrate, wherein the non-uniform tape has a thickness, at some points on the non-uniform tape no more than a fixed distance (Wr) from the first longitudinal edge, of more than 1.5 times the thickness of the non-uniform tape at the second longitudinal edge, Wr being a distance no greater than one half of Wt, the method comprising the steps of:
(a) determining a fold width (Wf) being a distance no greater than (Wt−Wr)/2;
(b) establishing a fold line on the substrate in the longitudinal direction at a distance equal to Wf from the second longitudinal edge, the fold line dividing the non-uniform tape into an outer portion between the fold line and the second longitudinal edge and an inner portion between the fold line and the first longitudinal edge;
(c) forming a folded tape by folding the substrate along the fold line to cause the bottom side of the substrate of the outer portion to be positioned adjacent to the bottom side of a sub-portion of the inner portion, the sub-portion comprising points at a distance of no more than Wf from the fold line; and
(d) winding the folded tape to form a roll of folded tape.

The establishment of the fold line may comprise scoring the top side of the substrate in the longitudinal direction at a distance equal to Wf from the second longitudinal edge to create a score line.

The thickness of the non-uniform tape at all points on the non-uniform tape at a distance of less than Wr from the first longitudinal edge may be between 1.75 and 2.25 times the average thickness of the tape at points on the tape at a distance of less than two times Wf from the second longitudinal edge.

The non-uniform tape may be masking tape wherein a portion of the tape, comprising those points at a distance of less than Wr from the first longitudinal edge, is reinforced.

The non-uniform tape may have a first uniform thickness at all points further than Wr from the first longitudinal edge, and also may have a second uniform thickness at all points at a distance of less than Wr from the first longitudinal edge. The second uniform thickness may be 1.75 to 2.25 times the first uniform thickness. The second uniform thickness may be about two times the first uniform thickness.

Wr may be a distance no greater than one quarter of Wt. Wf may be less than or equal to Wr. Wr may be a distance no greater than one tenth of Wt.

The invention further includes a roll of folded tape formed by the method summarized above. The roll of folded tape may be formed from non-uniform tape comprising masking tape having a longitudinal strip adhered to the top side of the substrate, the longitudinal strip having an outer edge, wherein the longitudinal strip has a longitudinal extent co-extensive with that of the substrate and is positioned on the substrate so that the outer edge of the longitudinal strip is substantially aligned with the first longitudinal edge of the substrate over the longitudinal extent of the substrate.

### BRIEF DESCRIPTION OF THE DRAWINGS

FIG. 1 is a plan view of a piece of non-uniform tape showing the fold line as a dashed line.

FIG. 2 is a cross-section of non-uniform tape through the line 2-2 of FIG. 1.

FIG. 3 is a perspective view of a roll of folded tape.

FIG. 4 is a cross-section of folded tape through the line 4-4 of FIG. 3.

### DETAILED DESCRIPTION OF THE INVENTION

Tape generally has an approximately uniform thickness at all points. However some types of tape have a greater thickness at and near one longitudinal edge than at the other edge. For example, when using masking tape, one longitudinal edge (the “first edge”) is normally covered with a coating material, which is allowed to partially dry, and when the tape is subsequently removed, there is a significant risk of the coated edge tearing, thereby causing the paint line not to be completely straight and well defined. One novel approach to help prevent such tearing is to reinforce one longitudinal edge of the tape. For example, a strip of material with a width 1/10 of the width of the substrate and having a longitudinal extent co-extensive with that of the substrate may be positioned on the substrate so that the outer edge of the longitudinal strip is substantially aligned with the first longitudinal edge of the substrate over the longitudinal extent of the substrate. This provides additional strength to the first edge to help prevent tearing, but it also increases the thickness of the tape near the first edge. This thickening can cause problems when the tape is rewound into a roll. For example, there will be space between successive (neighbouring) portions of the tape in the roll between the bottom adhesive layer at any point in the tape away from the first edge, where the tape is thinner than at the first edge, and the top side of the closest portion of the tape interior to the point in the roll. This can cause the adhesive surface to be exposed to air and dry out, or be otherwise compromised, due to this exposure. This also makes the tape difficult to wind (or rewind) on a roll without telescoping and deforming. Furthermore, the thinner, unreinforced edge of the tape can become wavy or rippled when handling.

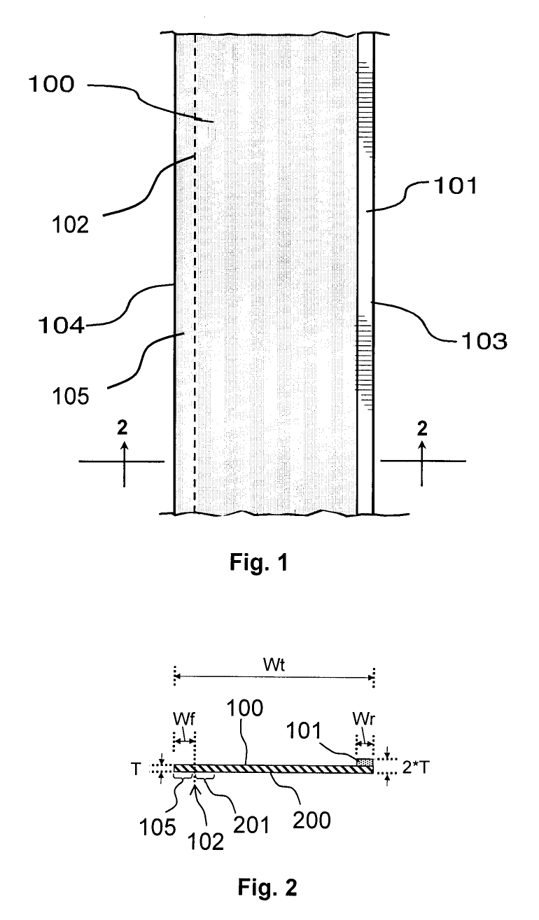

FIG. 1 shows a piece, or strip, of a non-uniform tape. The tape comprises a foldable substrate that is generally flexible, which may be, for example, formed from paper or plastic. The substrate 100, the top side of which is shown in FIG. 1, is typically of a uniform thickness so that the thickness (T) of the substrate 100 at all points on the tape is approximately equal. The substrate has a first longitudinal edge 103 and a second longitudinal edge 104. The non-uniform tape of FIG. 1 has been thickened towards the first longitudinal edge 103 by the adhesion of a longitudinal strip of reinforcing material 101 positioned on the top side of the substrate 100 so that the outer edge of the longitudinal strip 101 is substantially aligned with the first longitudinal edge 103 of the substrate 100 over the longitudinal extent of the substrate 100. In this case, the non-uniform tape is thickened over a portion of the tape that is within a distance equal to the width of the longitudinal strip 101, referred to as the “reinforcement width” (or “Wr”, as shown in FIGS. 2 and 4), from the first longitudinal edge 103. The longitudinal strip 101 may, for example, be made of the same material as the substrate, or may be made of a stronger material, such as biaxially-oriented polypropylene.

Other methods of reinforcing the substrate 100 that result in thickening of the substrate 100 at and near the first longitudinal edge 103 may also be used, or the substrate may simply be formed so that it is thicker towards the first longitudinal edge 103 to produce non-uniform tape.

When the non-uniform tape employs a longitudinal strip 101 for reinforcement, the thickness (T) of the longitudinal strip 101 is generally uniform, so that the overall thickness (the “reinforced thickness”) of the non-uniform tape in the reinforced region is also uniform. The reinforced thickness may be more than 1.5 times the thickness of the remainder of the tape (such as at the second longitudinal edge), and may be between 1.75 and 2.25 times the thickness of the remainder of the tape. In many cases, such as where the longitudinal strip 101 is made of the same material as the substrate 100, the reinforced thickness (2*T) may be about two times the thickness (T) of the remainder of the tape, the remainder of the tape having a substantially uniform thickness, as shown in the embodiment depicted in FIG. 2. It is preferred to select the material used for the longitudinal strip 101 to have the same thickness (T) as the substrate 100, the substrate 100 having a uniform thickness, in which case the benefits of the methods described herein are maximized.

There is generally a pressure-sensitive adhesive layer formed on the bottom side 200 of the substrate 100. For example, this may be a natural or synthetic rubber or an acrylic compound. The adhesive layer is not shown separately in the Figures and should be understood, unless other expressly stated or clearly implied, to be included in references to the substrate 100, as being formed on the bottom side 200 of the substrate 100.

The reinforcement width is generally a distance no greater than one half of the width of the substrate (Wr<=Wt/2, the width of the unfolded substrate being referred to as “Wt”, as shown in FIG. 2), and preferably a distance no greater than one quarter of the width of the substrate (Wr<=Wt/4), and more preferably no greater than one tenth of the width of the substrate (Wr<=Wt/10). For a substrate with a width of one inch (25.4 mm), for example, a reinforcement width of about one sixteenth of an inch (1.6 mm) may be suitable.

In other forms of non-uniform tape, the thickness of the reinforced portion may not be uniform. For example it may be thickest at the first longitudinal edge 103 and gradually decrease to the thickness of the unreinforced portion of the non-uniform tape, or the thickness may vary cyclically or otherwise in the longitudinal direction.

The invention comprises a method of forming such a non-uniform tape into a roll. The first step is to predetermine a fold width (“Wf”), which is a distance from the second longitudinal edge 104 at which the tape will later be folded. In general, the fold width is selected to be less than or equal to one half of the difference between the width of the substrate and the reinforcement width (Wf<=(Wt−Wr)/2), so that when the tape is folded, the folded portion will not overlap the reinforced portion. Generally this means that Wf is less than or equal to one-quarter of Wt (Wt/4). The fold width may be predetermined to be less than or equal to the reinforcement width (Wf<=Wr). In many cases, a fold width equal to the reinforcement width (Wf=Wr) may be preferred. The choice of fold width may depend on the material of which the substrate is made, and should be sufficiently large to ensure good contact between the layers of tape in the roll of folded tape to be formed, so that the passage of air to the inside of a roll of the folded tape is minimized. In many cases, a fold width of about one sixteenth of an inch (1.6 mm) may be suitable for a substrate with a width of at least one half of one inch (12.7 mm) and a reinforcement width of no more than one half of the width of the substrate. For example, for a non-uniform tape with a substrate width of one inch (25.4 mm) and a reinforcement width of one sixteenth of an inch (1.6 mm), a fold width of about one sixteenth of an inch (1.6 mm) may be appropriate.

The second step is to establish a fold line 102 on the substrate in the longitudinal direction at a distance equal to the fold width from the second longitudinal edge 104, the fold line dividing the tape into an outer portion 105 between the fold line 102 and the second longitudinal edge 104 and an inner portion between the fold line 102 and the first longitudinal edge 103. Such a fold line 102 is depicted in FIG. 1 as a dashed line parallel to the longitudinal edges 103, 104 of the non-uniform tape. A preferred way to establish the fold line 102 is to score the top side of the substrate 100 in the longitudinal direction at a distance equal to the fold width from the second longitudinal edge 104, thereby creating a score, or “score line” that facilitates automated folding of the tape. The scoring can be done by using a blade that penetrates through the top of and into, but not through, the substrate 100. For example, it may penetrate into the substrate by a distance between one tenth and one half of the thickness of the substrate, such as by a distance of about one quarter of the thickness of the substrate 100.

The third step is to fold the scored non-uniform tape along the fold line 102 to cause the bottom (adhesive) side 200 of the substrate 100 of the outer portion 105 to be positioned adjacent to the bottom (adhesive) side 200 of a sub-portion 201 of the inner portion, the sub-portion comprising points within a distance of the fold width from the fold line, to form a folded portion 400, as shown in FIG. 4, having a width equal to the fold width and a thickness of about twice the thickness of the substrate 100. The adjacent bottom sides of the outer and inner portions (201, 105) in the folded portion 400, which are covered with adhesive, may thereby adhere to each other. While this means that the resulting folded portion 400 does not have any adhesive exposed, this does not affect the operation of the tape for many purposes. For example, when the tape is masking tape, it is the reinforced edge (being the first longitudinal edge 103) that is intended to be used to define the paint line, and so a lack of adhesive on the bottom side of the tape away from the first longitudinal edge does not affect the function of the tape. In fact such a non-adhesive portion of the folded tape may facilitate removal of the folded tape by making it easier for a user to grasp the folded portion 400, which will generally not stick to the surface being painted, between the user's fingers so that the tape can be pulled away from the surface to which it was adhered.

FIG. 4 shows a transverse cross-section though a folded tape that shows that the thickness of the folded portion 400 is about twice that of the unreinforced portion of the unfolded tape. In the depicted preferred embodiment, the longitudinal strip 101 is made of a different material than is the substrate, but has approximately the same thickness, so that the total thickness of the folded tape within a distance of the reinforcement width (Wr) from the first longitudinal edge 103 is also about twice the thickness of the unreinforced portion of the unfolded tape. While the respective top and bottom sides of the reinforced portion of the tape and of the folded portion 400 of the tape are depicted in FIG. 4 as being vertically offset from each other by the width of the substrate 100, the tape is generally flexible so that the bottom of the reinforced portion can be displaced downward by about the width of the substrate 100 in order to align it with the bottom of the folded portion 400 for purposes of attaching the tape to a surface or putting it on a roll. The bottom of the portion of the folded tape extending from the second longitudinal edge 104 to the first longitudinal edge 103 is an adhesive layer that can be attached to a surface by applying pressure to the top side of the tape. As noted above, since the bottom of the folded portion 400 does not have adhesive, a user can lift the folded portion to easily remove the tape from a surface, or from a roll of folded tape.

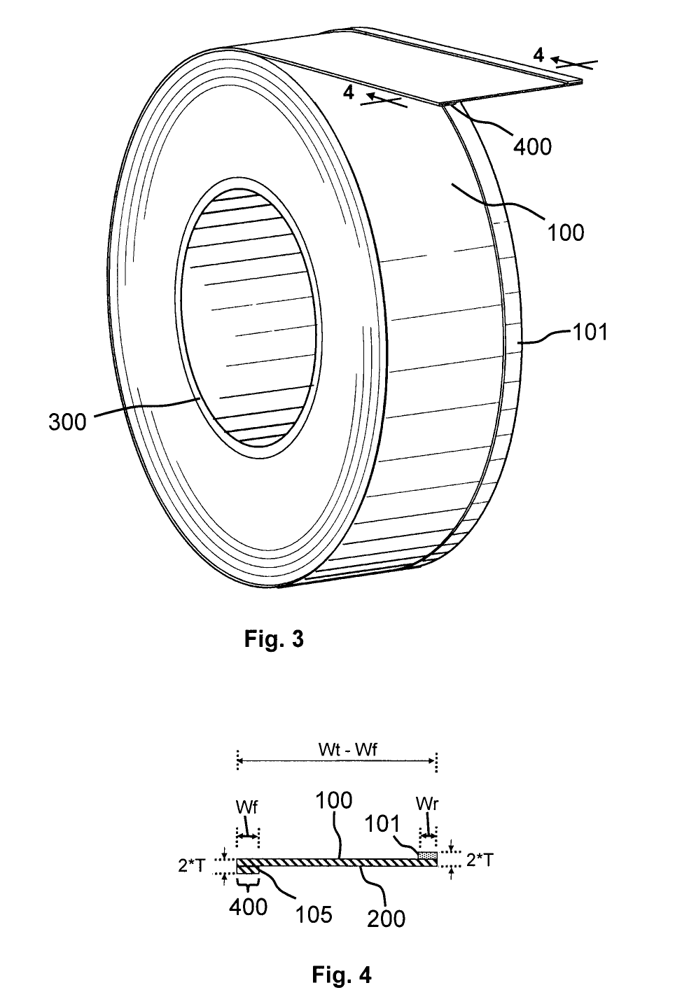

The final step is to wind the folded tape to form a roll, such as that shown in FIG. 3. This may be done using a winding machine and the folded tape may be rewound onto a core 300, although the use of a core 300 is not essential.

It should be emphasized that the above-described embodiments of the present invention, particularly, any “preferred” embodiments, are possible examples of implementations, merely set forth for a clear understanding of the principles of the invention. Many variations and modifications may be made to the above-described embodiment(s) of the invention as will be evident to those skilled in the art.

Where, in this document, a list of items is prefaced by the expression “such as” or “including”, is followed by the abbreviation “etc.”, or is prefaced or followed by the expression “for example”, or “e.g.”, this is done to expressly convey and emphasize that the list is not exhaustive, irrespective of the length of the list. The absence of such an expression, or another similar expression, is in no way intended to imply that a list is exhaustive. Unless otherwise expressly stated or clearly implied, such lists shall be read to include all comparable or equivalent variations of the items, and alternatives to the items, in the list that a skilled person would understand would be suitable for the purpose that the items are listed.

The words “comprises” and “comprising”, when used in this specification and the claims, are to used to specify the presence of stated features, elements, integers, steps or components, and do not preclude, nor imply the necessity for, the presence or addition of one or more other features, elements, integers, steps, components or groups thereof.

The scope of the claims that follow is not limited by the embodiments set forth in the description. The claims should be given the broadest purposive construction consistent with the description as a whole.

1. A method for forming tape having non-uniform thickness into a roll, the non-uniform tape comprising a longitudinally elongated substrate having top and bottom sides, first and second longitudinal edges and a width (Wt), the non-uniform tape further comprising an adhesive layer formed on the bottom side of the substrate, wherein the non-uniform tape has a thickness, at some points on the non-uniform tape no more than a fixed distance (Wr) from the first longitudinal edge, of more than 1.5 times the thickness of the non-uniform tape at the second longitudinal edge, Wr being a distance no greater than one half of Wt, the method comprising the steps of:
(a) determining a fold width (Wf) being a distance no greater than (Wt−Wr)/2;
(b) establishing a fold line on the substrate in the longitudinal direction at a distance equal to Wf from the second longitudinal edge, the fold line dividing the non-uniform tape into an outer portion between the fold line and the second longitudinal edge and an inner portion between the fold line and the first longitudinal edge;
(c) forming a folded tape by folding the substrate along the fold line to cause the bottom side of the substrate of the outer portion to be positioned adjacent to the bottom side of a sub-portion of the inner portion, the sub-portion comprising points at a distance of no more than Wf from the fold line; and
(d) winding the folded tape to form a roll of folded tape.

2. The method of claim 1, wherein establishing a fold line comprises scoring the top side of the substrate in the longitudinal direction at a distance equal to Wf from the second longitudinal edge to create a score line.

3. The method of claim 1, wherein the thickness of the non-uniform tape at all points on the non-uniform tape at a distance of less than Wr from the first longitudinal edge is between 1.75 and 2.25 times the average thickness of the tape at points on the tape at a distance of less than two times Wf from the second longitudinal edge.

4. The method of claim 1, wherein the non-uniform tape is masking tape wherein a portion of the tape, comprising those points at a distance of less than Wr from the first longitudinal edge, is reinforced.

5. The method of claim 1, wherein the non-uniform tape has a first uniform thickness at all points further than Wr from the first longitudinal edge, and also has a second uniform thickness at all points at a distance of less than Wr from the first longitudinal edge.

6. The method of claim 5 wherein the second uniform thickness is 1.75 to 2.25 times the first uniform thickness.

7. The method of claim 6 wherein the second uniform thickness is about two times the first uniform thickness.

8. The method of claim 7, wherein Wf is less than or equal to one quarter of Wt.

9. The method of claim 8, wherein Wr is less than or equal to one quarter of Wt.

10. The method of claim 9, wherein Wf is less than or equal to Wr.

11. The method of claim 10, wherein Wr is a distance no greater than one tenth of Wt.

12. A roll of folded tape formed by the method of claim 1.

13. The roll of folded tape of claim 12, wherein the non-uniform tape comprises masking tape having a longitudinal strip adhered to the top side of the substrate, the longitudinal strip having an outer edge, wherein the longitudinal strip has a longitudinal extent co-extensive with that of the substrate and is positioned on the substrate so that the outer edge of the longitudinal strip is substantially aligned with the first longitudinal edge of the substrate over the longitudinal extent of the substrate.
